(19) United States
(12) Patent Application Publication
(10) Pub. No.: US 2012/0061874 A1
(43) Pub. Date: Mar. 15, 2012

(54) TIRE FILLING COMPOUND, METHOD FOR PRODUCING A TIRE FILLING, AND APPARATUS FOR IMPLEMENTING THE METHOD

(75) Inventors: Paul Roesler, Dortmund (DE); Martin Roesler, Dortmund (DE)

(73) Assignee: ROESLER TYRE INNOVATORS GMBH & CO. KG, Dortmund (DE)

(21) Appl. No.: 13/321,003

(22) PCT Filed: Jun. 4, 2010
(86) PCT No.: PCT/EP2010/003390

§ 371 Date: Nov. 17, 2011

(30) Foreign Application Priority Data
Jun. 6, 2009 (DE) 10 2009 024 088.8

(51) Int. Cl. B29B 7/42; C08L 75/04; B29C 45/14; C08K 11/00

(52) U.S. Cl. 264/267; 524/703; 425/200

(57) ABSTRACT

The invention relates to a tire-filling compound for vehicles, particularly for utility vehicles, consisting of a polyurethane component and a solid particle component, wherein the polyurethane component consists of a two-component polyurethane elastomer, wherein the solid particle component is formed from cork particles, as well as to a method for the production of a tire filling having such a tire-filling compound, and to an apparatus for implementation of the method.

The invention relates to a tire-filling compound for vehicles, particularly for utility vehicles, in accordance with the preamble of claim 1, a method for the production of a tire filling, in accordance with the preamble of claim 4, and an apparatus for implementation of such a method, in accordance with the preamble of claim 8.

Utility vehicles that are provided with air-filled tires have the disadvantage, during their usual use above all on rough terrain or construction sites, that the tires are exposed to great risk of damage and lose air in the event of damage, which makes handling such utility vehicles significantly more difficult or completely impossible. Furthermore, there is the risk that in the event of destruction of a tire, the operator of the utility vehicle or persons standing in the vicinity can be injured. These disadvantages have led to the result that many utility vehicles are provided with so-called “puncture-free tires.”

The use of elastomer polyurethane plastics as tire-filling compounds is particularly widespread; an example of such a tire-filling compound is described in DE 40 38 996 C2. These tire-filling compounds consist of a liquid A-polyurethane component and a liquid B-polyurethane component, which are introduced into a tire at high pressure, and react with one another in the tire interior, and harden there.

Aside from these two-component tire-filling compounds, three-component tire-filling compounds are also known, which have not only two liquid polyurethane components but, in addition, a solid rubber granulate component. Such a tire-filling compound demonstrates better physical properties; in particular, the elasticity is clearly improved thereby. Such a tire-filling compound on a polyurethane basis with an additional rubber granulate component is distributed by the applicant, together with a suitable filling system, and has already proven itself well in practice. However, the solid component is restricted to about 50 vol.-% of the total filling volume, due to processing conditions, and the total weight of a correspondingly filled tire is relatively high, thereby clearly increasing the total weight of the utility vehicle, and this leads to greater energy consumption, among other things.

It is the task of the invention to make available a tire-filling compound as well as a method and an apparatus for its production, which allows a noteworthy saving in weight, without impairment of its properties.

This task is accomplished, in the case of a tire-filling compound of the type indicated initially, according to the invention, in that the solid particle component is formed by cork particles.

It has surprisingly turned out that cork particles are suitable as a solid component for a tire-filling compound, whereby in combination with a two-component polyurethane elastomer that is liquid in the starting state, an elastic tire-filling compound can be produced. In this connection, depending on the cork proportion, the weight of a tire-filling compound can be significantly reduced as compared with known tire-filling compounds, for example up to a magnitude of 30%. Furthermore, such a tire-filling compound is better for the environment, because cork is a renewable natural resource. Alternatively, of course, synthetic cork can also be used, if this is available.

It has turned out that it is possible that the volume proportion of the cork particles, with reference to the total volume, can amount to between 50 and 60 vol.-%. The total weight of the tire-filling compound can be reduced accordingly, by means of this high cork proportion.

The cork particles themselves do not need to have any particular geometric shape; in particular, it is not necessary for the cork particles to have the same shape. Preferably, cork particles whose maximal longitudinal expanse lies between 0.5 to 1.5 mm are used.

Polyurethane elastomers that are based on the following basic materials are preferably used as two-component polyurethane elastomers:
polyether polyol, approximately 30 to 40 wt.-%,
primary and secondary plasticizers, for example: process oil from the mineral oil industry, alternatively or additively, oil from coal processing (tar oil), approximately 40 to 60 wt.-%,
aromatic isocyanates, 5 to 10 wt.-%,
additionally, catalysts, cross-linking agents, and chain-lengthening agents, with a proportion <5 wt.-%.

In this connection, the A-polyurethane component preferably consists of
approximately 54 to 60 wt.-% polyether polyol,
36 to 40 wt.-% primary and secondary plasticizers,
2 to 5 wt.-% chain-lengthening agents/cross-linking agents/catalysts,
   and the B-polyurethane component of
approximately 14 to 16 wt.-% polyether polyol,
12 to 20 wt.-% aromatic isocyanates,
66 to 72 wt.-% plasticizers.

According to the invention, a tire filling having a tire-filling compound as described above can be produced in that the tire-filling compound is mixed from a liquid A-polyurethane component, a liquid B-polyurethane component, and from cork particles, the mixed tire-filling compound is then introduced into a tire, and hardened in the tire interior.

In this connection, the tire-filling compound is preferably conveyed into the tire at a system pressure between 15 and 20 bar.

A tire-filling compound having a volume proportion of the cork particles in the total volume between 50 and 80 vol.-% is used, whereby the cork particles preferably have a maximal longitudinal expanse between 0.5 to 1.5 mm. The bulk density of the cork particles lies between 70 to 80 kg/m³, for example. The density of the cork in the mixture lies at approximately 100 to 120 g/dm³.

In order to be able to produce a tire filling as described above from a tire-filling compound, and to introduce it into a tire, the invention also provides for an apparatus having the characteristics of claim 8.

Fundamentally, apparatuses of this type, intended for other purposes of use, having an eccentric spiral pump and a conveying screw are known; an example of such an apparatus is described in DE 101 60 335 B4. A specially configured conveying screw is disclosed in DE 10 2006 036 243 A1; DE 10 2004 038 686 B3 describes a suitable eccentric spiral pump without a conveying and mixing device.

According to the invention, the apparatus is characterized in that the conveying screw is provided with interruptions in the region of the at least one filling opening.

It has turned out that significantly better wetting of the solid particles with the two liquid components takes place by means of the provision of interruptions of the conveying screw in the region of the liquid feed (filling opening), as compared with conventional conveying screws, and this promotes mixing and conveyability even in the case of a high dry-material content.

In a further preferred embodiment of the invention, it is provided that the housing has a friction-reducing inner lining. This inner lining preferably consists of PTFE.

Thorough mixing of the components can be further clearly improved in that the housing has rod-shaped elements that project into the housing interior, in the region of the at least one filling opening.

The effectiveness of the rod-shaped elements can be further improved in that the rod-shaped elements are adjustably affixed on the housing. For this purpose, they can be provided with a thread that can be screwed into the housing wall to a greater or lesser degree.

In the following, the invention will be explained as an example, using the drawing. This shows, in:

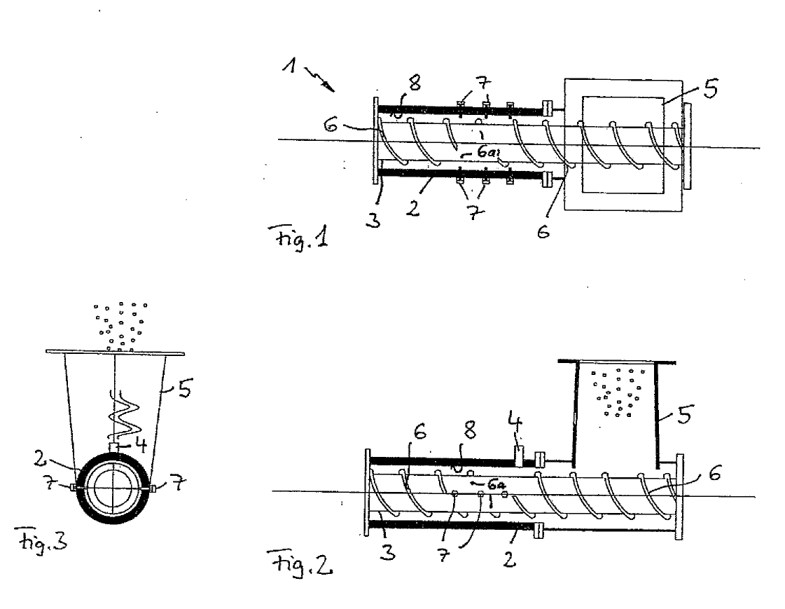

FIG. 1 a top view of a conveying and mixing device of the apparatus according to the invention,

FIG. 2 a side view of the conveying and mixing device, and

FIG. 3 a front view of the conveying and mixing device.

An apparatus according to the invention, for the production of a tire filling from a tire-filling compound, has an eccentric spiral pump, not shown, a conveying and mixing device, shown in detail, and at least one drive motor, not shown.

The conveying and mixing device of the apparatus, structured according to the invention, is designated in general with 1. This conveying and mixing device 1 first of all has a tubular housing 2, in which a tubular shaft 3 is disposed and mounted. This shaft 3 has a shaft coupling at both ends, in each instance, which coupling is not shown. The left shaft end, in the sense of FIGS. 1 and 2, is configured to be connected with the rotor of the eccentric spiral pump, not shown, so as to rotate with it. The other shaft end of the shaft 3 is provided with a coupling with which it can be coupled to a drive motor, not shown. The basic structure of the apparatus with the mixing and conveying device 1 thus corresponds to the example of what is shown in DE 101 60 335 B4.

Approximately in the region of the central longitudinal expanse of the housing 2, the housing 2 has at least one filling opening 4. At a distance from this filling opening 4, a filling funnel 5 is furthermore provided, in the end region of the housing 2 that faces the pump, not shown.

The tubular shaft 3 is surrounded by a conveying screw 6 that is welded onto the tubular shaft 3, for example. It is essential in this connection that the conveying screw 6 is provided with interruptions in the region of the filling opening 4 and downstream of it. These regions are indicated with 6a.

Furthermore, in the region of the filling opening 4 and thus in the region of the interruptions 6a of the conveying screw 6, rod-shaped elements 7 are provided, which project through the housing 2 into the housing interior. In this connection, the rod-shaped elements 7 are preferably affixed to the housing 2 in adjustable manner; for example, they have a thread for this purpose, and can be screwed into the housing wall of the housing 2 to a greater or lesser extent, so that they project into the housing interior to a greater or lesser extent.

Furthermore, the housing 2 is provided with a friction-reducing inner lining 8, which consists, for example, of a PTFE pipe, which is inserted into the tubular housing 2, which consists of VA steel, for example.

A connector hose, not shown, is connected with the at least one filling opening 4; this hose stands in connection with a liquid reservoir of an A-polyurethane component and a B-polyurethane component. The filling funnel 5 serves for filling in cork particles.

For the production of a tire-filling compound according to the invention, or a tire filling formed from it, between 50 and 80 vol.-% cork particles are filled into the apparatus, i.e. into the conveying and mixing device 1 of the apparatus, by way of the filling funnel 5, and between 50 and 20 vol.-% two-component polyurethane elastomer are filled in by way of the filling opening 4. In this connection, the size of the cork meal preferably lies at about 0.5 to 1.5 mm (greatest longitudinal expanse), and the bulk density at approximately 70 to 80 kg/m³. The density of the cork amounts to approximately 100 to 120 g/dm³. A system pressure between 15 to 20 bar is built up by the pump, not shown, so that a conveying amount of about 20 to 30 l/min can be achieved. Perfect mixing and perfect conveying of the tire-filling compound are guaranteed by means of the special configuration of the conveying and mixing device 1 of the apparatus. Better wetting of the solid particles with the liquid components is guaranteed by means of the configuration of the conveying screw, i.e. the interruptions 6a; thorough mixing is improved by the rod-shaped elements 7; the inner lining 8 prevents adhesion of the tire-filling compound to the inside wall of the conveying and mixing device 1.

Polyurethane elastomers that are based on the following basic materials are preferably used as two-component polyurethane elastomers:
polyether polyol, approximately 30 to 40 wt.-%,
primary and secondary plasticizers, for example: process oil from the mineral oil industry, alternatively or additively, oil from coal processing (tar oil), approximately 40 to 60 wt.-%,
aromatic isocyanates, 5 to 10 wt.-%,
additionally, catalysts, cross-linking agents, and chain-lengthening agents, with a proportion <5 wt.-%.

In this connection, the A-polyurethane component preferably consists of
approximately 54 to 60 wt.-% polyether polyol,
36 to 40 wt.-% primary and secondary plasticizers,
2 to 5 wt.-% chain-lengthening agents/cross-linking agents/catalysts,
   and the B-polyurethane component of
approximately 14 to 16 wt.-% polyether polyol,
12 to 20 wt.-% aromatic isocyanates,
66 to 72 wt.-% plasticizers.

A tire filled with a tire-filling compound according to the invention demonstrates a significant weight saving as compared with conventionally filled tires. A test tire having the dimension 405/70 R 20 weighed approximately 103 kg empty, and approximately 264 kg when filled with a cork filling according to the invention. The filling according to the invention therefore weighed approximately 161 kg. An otherwise usual filling according to the state of the art, in contrast, weighs 220 kg. It is evident that a significant weight saving can be achieved in this way.

1. Tire-filling compound for vehicles, particularly for utility vehicles, consisting of a polyurethane component and a solid particle component, wherein the polyurethane component consists of a two-component polyurethane elastomer, wherein the solid particle component is formed from cork particles.

2. Tire-filling compound according to claim 1, wherein the volume proportion of the cork particles, with reference to the total volume, amounts to between 50 and 80 vol.-%.

3. Tire-filling compound according to claim 1, wherein the cork particles have a longitudinal expanse between 0.5 to 1.5 mm.

4. Method for the production of a tire filling having a tire-filling compound according to claim 1, wherein the tire-filling compound is mixed from a liquid A-polyurethane component, a liquid B-polyurethane component, and from cork particles, the mixed tire-filling compound is subsequently introduced into a tire, and hardened in the tire interior.

5. Method according to claim 4, wherein the tire-filling compound is conveyed into the tire at a system pressure between 15 to 20 bar.

6. Method according to claim 4, wherein a tire-filling compound having a volume proportion of the cork particles in the total volume between 50 and 80 vol.-% is used.

7. Method according to claim 6, wherein the cork particles have a longitudinal expanse between 0.5 to 1.5 mm.

8. Apparatus for implementation of the method according to claim 4, having an eccentric spiral pump and a conveying and mixing device that has a conveying screw disposed on a shaft, wherein the shaft of the conveying screw is connected with the rotor of the eccentric spiral pump by way of a coupling, and the conveying screw is surrounded by a housing that has a filling funnel in the end region that faces away from the eccentric spiral pump, and at least one filling opening at a distance from the filling funnel, wherein the conveying screw (6) is provided with interruptions (6a) in the region of the at least one filling opening (4).

9. Apparatus according to claim 8, wherein the housing (2) has a friction-reducing inner lining (8).

10. Apparatus according to claim 9, wherein the inner lining (8) consists of PTFE.

11. Apparatus according to claim 8, wherein the housing (2) has rod-shaped elements (7) that project into the housing interior, in the region of the at least one filling opening (4).

12. Apparatus according to claim 11, wherein the rod-shaped elements (7) are affixed on the housing (2) in adjustable manner.
